(19) United States
(12) Patent Application Publication
(10) Pub. No.: US 2010/0313774 A1
(43) Pub. Date: Dec. 16, 2010

(54) METHOD FOR PRODUCING A WATERLESS TEMPORARY TATTOO

(76) Inventors: Peter Reiselt, Downers Grove, IL (US); Joseph A. Galloni, Bartlett, IL (US)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/483,621

(22) Filed: Jun. 12, 2009

(51) Int. Cl. B41M 1/12

(52) U.S. Cl. 101/129

(57) ABSTRACT

A waterless temporary tattoo that has bright colors is provided. The waterless temporary tattoo is produced from a film having a pretreated printing surface and opposing adhesive surface. An opaque tattoo image is printed upon the printing surface of the film using a screen printing process, and then subsequently dried or cured by using forced heat or by air drying. The completed screen printed tattoo image is then rotary die cut to conform the film to the shape of the tattoo image to produce the completed waterless temporary tattoo.

### TECHNICAL FIELD

Generally, the present invention relates to temporary tattoos and methods for producing the same. More particularly, the present invention relates to waterless temporary tattoos and methods for producing the same.

### BACKGROUND ART

The desire to adorn one's body with various stylized or artistic decorations using traditional needle-based tattoos has gained significant popularity during the last several decades. However, the process of getting tattooed is generally painful, costly, and can lead in some instances to the contraction of diseases if proper hygiene protocols are not followed. Additionally, traditional tattoos require the application of dye or ink into the layers of the skin to form an image that is generally permanent, and cannot be readily changed to a new image. And while tattoos can be removed by a dermatologist or other trained professional using a laser, such a process is costly and may result in permanent discoloration in the areas of the skin being treated.

To overcome some of the drawbacks of traditional needle-based tattoos, several alternative temporary tattoo techniques have been developed, including: painted image temporary tattoos, and transferable dye image temporary tattoos. These alternative techniques have sought to give the appearance of detailed skin or body images without the permanency or pain associated with needle-based tattoos. In particular, painted images can provide a high quality image, but are relatively expensive to receive. With regard to transferable dye images, they are typically printed on a paper carrier to form a pattern or image. The paper carrier is wetted with water and pressed against the skin to transfer the image to the skin. This method of application tends to produce partial images, as well as images that are streaked and/or smeared. Furthermore, some of the dyes used in transferable dye images are water-soluble and will run and streak easily from perspiration. The transferable dye images also tend to have low opacity, or are partially transparent, and allow the color of the recipient's skin to pass through the printed image, causing the colors of the dye image to lack brightness resulting in an image that is muted or washed out in appearance. In addition, because there is no barrier material separating the printed dye image from the skin, the dye may cause skin irritation. Moreover, to remove the temporary tattoo image, rubbing alcohol, soap and water, baby oil, cold cream, or the like must be used.

Another type of transferable dye image is printed over a substrate of adhesive on a paper carrier to form a pattern or image. To apply, the carrier is place image-side down on the skin, and the paper backing is wetted with water. This releases the adhesive from the carrier and adheres the image to the skin. Once applied, the image is waterproof, and cannot be washed off. It must be removed by pressing tape over the image and lifting away, or dissolved with rubbing alcohol or baby oil.

With any of the above methods, improper removal (typically rubbing, scrubbing, or scratching) can cause skin irritation or damage.

Therefore, there is a need in the art for a method of making a hypoallergenic temporary tattoo that utilizes a screen printed tattoo image that is dried using forced air heat or room temperature heating, resulting in an image with sharp colors and enhanced whiteness, and that is applied and removed without any other materials or tools needed.

### SUMMARY OF INVENTION

Any one or more of the foregoing aspects of the present invention, together with the advantages thereof over the known art relating to the method for producing a waterless temporary tattoo, which shall become apparent from the specification and drawings that follows, may be accomplished by the invention as hereinafter described and claimed.

In general, the present invention provides a method of producing a waterless temporary tattoo comprising, providing a film having an adhesive surface opposite a printing surface pretreated with a corona treatment; screen printing a tattoo image upon said printing surface; and then drying said tattoo image under one of forced air heat and air drying.

Advantageously, it will be appreciated that, in at least one of the embodiments of the present invention, a waterless temporary tattoo is produced by a method to provide sharp color and bright white images.

### BRIEF DESCRIPTION OF THE DRAWINGS

One or more objects and advantages of the present invention will become apparent from the subsequent detailed description of the preferred embodiment and the appended claims taken in conjunction with the accompanying drawings where:

FIG. 1 is a block diagram showing the steps for producing a waterless temporary tattoo in accordance with the concepts of the present invention.

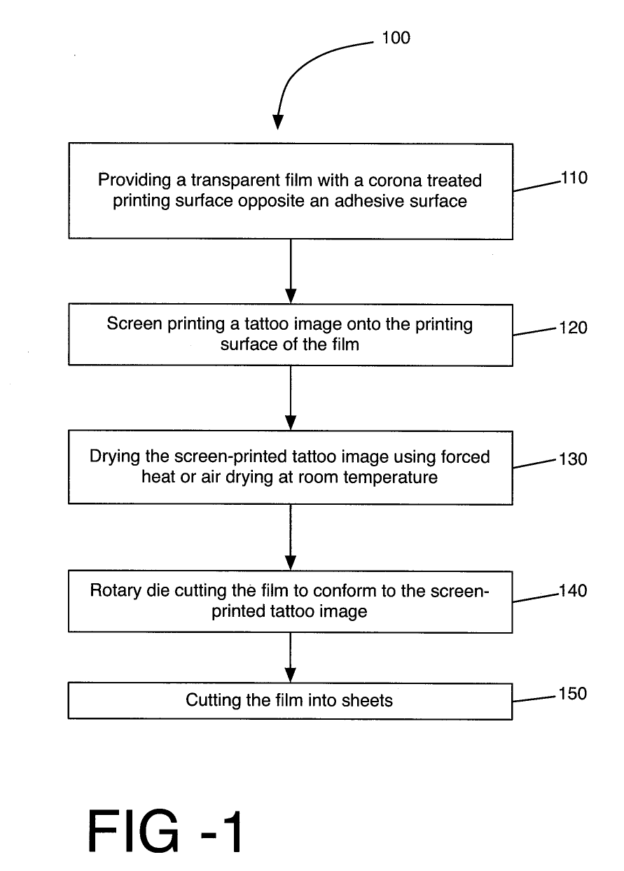

### DETAILED DESCRIPTION OF THE INVENTION

A method for producing waterless temporary tattoos in accordance with the concepts of the present invention is generally referred to by the numeral 100. In one embodiment, the temporary tattoos of the present invention may be printed on pressure-sensitive tape or film specially developed for contact with the skin. In another embodiment, the temporary tattoo images may be screen printed on the non-tacky side of the film that has been pre-treated with a corona or air-plasma process or treatment, resulting in opaque images that have bright colors, with high intensity whiteness. In addition, in at least one embodiment, the pressure sensitive film and inks used to form the tattoo images should be cosmetic grade and, thus, hypoallergenic to reduce the potential for irritation on the recipient's skin. In one embodiment, the temporary tattoos are applied to a recipient's skin. In other embodiments, the temporary tattoos can be applied to other solid surfaces, such as glass, paper, wood, and plastic, for example.

The method of producing a waterless temporary tattoo is carried out by supplying a roll or other suitable section of film, such as transparent film, having a printing surface that is opposite an adhesive surface, as indicated at step 110. For example, the transparent film may comprise a polyethylene film, such as a polyethylene film that has a printing surface that has been corona treated on one side and an opposing hypoallergenic pressure sensitive acrylate adhesive surface on the other side. Such a film is available commercially from 3M Company, Minneapolis, Minn. However, it should be appreciated that the film used in the process may comprise any suitable film, including films other than polyethylene, provided those films have an adhesive surface treated with a suitable pressure-sensitive adhesive on one side and a printing surface that is air plasma treated, or corona treated, on the other. Thus, it should be appreciated that the film, adhesive and ink used to form the completed screen printed temporary tattoo of the present invention may be hypoallergenic.

In one embodiment, the printing surface may be pre-treated with a corona or air plasma treatment. It will be appreciated that the air plasma or corona treatment of the printing surface allows the film to more readily accept the tattoo image that is applied thereto using a screen printing process to be discussed. Specifically, the corona or air plasma process relates to exposing the printing surface of the film to an electrical discharge, or “corona.” Oxygen molecules within the discharge area break into their atomic form and freely bond to the ends of the molecules in the printing surface, resulting in a chemically activated surface with increased surface tension that is conducive to the adhesion of inks thereto.

Alternatively, in another embodiment where the film is not pretreated with the air plasma or corona process, and/or the film lacks an adhesive surface, the process 100 includes the steps of treating the printing surface of the film with an air plasma or corona treatment and disposing an adhesive upon the adhesive surface of the transparent film.

To protect the adhesive surface, the film also includes a release liner that is disposed upon the adhesive surface of the film. The release liner can be subsequently peeled away or otherwise released therefrom prior to applying the temporary tattoo to the recipient's skin.

Next at step 120, tattoo images are applied upon the printing surface of the film using a screen printing or serigraphy process. In one embodiment, the screen printing process may be carried out by one of a flat-bed roll form press, a flat bed sheet form press, a roll form cylinder press, and any other suitable screen printing apparatus. To reduce the potential for reaction with the ink or pigments used in the present invention, the inks and pigments may be cosmetic grade, and as such, do not contribute to the formation of skin irritation or rashes that may otherwise occur if non-cosmetic grade inks or pigments were used.

In general, the screen printing process is carried out by the use of a stencil, ink, and a screen. The stencil may comprise an indirect, direct, or direct/indirect stencil. In one embodiment, an indirect stencil may be used. The indirect stencil is a photographic stencil, which is produced independently of the screen fabric and is applied to the screen after exposure. In another embodiment, a direct stencil may be used. The direct stencil utilizes photosensitive material applied to the screening fabric so that after exposure, the stencil becomes part of the fabric. In another embodiment, a direct/indirect stencil may be used. The direct/indirect stencil is a combination of the direct and indirect stencil types.

In addition to the stencil and screen and in at least one embodiment, the ink used for screen printing is formulated to the desired color before printing of the tattoo image takes place, and as such, produces tattoo images that are more opaque than tattoo images produced by other printing techniques, such as flexography, while producing colors that are bright, and high contrast. It should also be appreciated that the whiteness achieved using screen printing are substantially brighter than that achievable with other printing processes, such as flexography. This is in contrast to the tattoo images produced from flexographic or other printing processes that are partially transparent and that are dull, and muted due to the formation of images produced by the overlap of cyan, magenta, yellow, and black (CMYK).

Thus, during the formation of a screen printed tattoo image, multiple stencils are used to produce each individual image component of the complete tattoo image that is a different color. As such, during the production of the temporary tattoo, the screen is placed adjacent to the printing surface of the film. Next, the stencil is placed upon the screen and the cosmetic ink is applied thereon and distributed by a squeegee or other apparatus where the ink passes through the cutouts in the stencil. Once, the ink has been deposited on the printing surface of the film, additional stencils are added to produce other components of the completed image that are shown in different colors. If other components of the image are to be formed using other colors, subsequent stencils with corresponding cutouts are used with the appropriate colored ink. In one embodiment, the different colors are applied at different screen printing stations. In other embodiments, the different colors may be applied at the same screen printing stations, but with different screens. Thus, the screen printed tattoo image is formed from a series of layered image components of varying colors.

While the prior discussion sets forth the general manner for producing screen printed tattoo images, specific screen printing systems may be used to generate the tattoo image, including a flat-bed roll form press, a flat bed sheet form press, and a roll form cylinder press. In particular, flat-bed and cylinder screen presses are similar in that both use a flat screen and a three step reciprocating process to perform the printing of the tattoo image. Specifically, to produce the screen printed image, the screen is first moved into position over the substrate, the squeegee is then pressed against the mesh and drawn over the image area, and then the screen is lifted away from the substrate to complete the process of forming a tattoo image. Thus, in a flat-bed press, the substrate to be printed is positioned on a horizontal print bed that is parallel to the screen, whereas with a cylinder press the substrate is mounted on a cylinder. It will be appreciated that sheet form presses use sheets of material, while roll form presses uses rolls of material.

In one embodiment using rotary cylinder screen presses, these presses are designed for continuous, high-speed web printing. The screens used on rotary screen presses are seamless thin metal cylinders that are open-ended and capped at both ends and fitted into blocks at the side of the press. During printing, ink may be pumped into one end of the cylinder so that a fresh supply can be constantly maintained. The squeegee is a free floating steel bar inside the cylinder and squeegee pressure is maintained and adjusted by magnets mounted under the press bed. In rotary printing, the web travels at a consistent speed between the screen and a steel or rubber impression roller immediately below the screen. As the web passes through the rotary unit, the screen spins at a rate that identically matches the speed of substrate movement. Additionally, the edge of the squeegee makes contact with the inside surface of the screen precisely at the point where the screen, substrate, and impression roller come together. The motion of the screen causes the ink to roll, which forces ink into stencil openings, essentially flooding the screen without requiring a floodbar. The squeegee then shears the ink as the stencil and substrate come into contact, allowing the ink to transfer cleanly to the material.

Thus, rotary printing is a continuous, stepless image-transfer method. The geometry of the screen and the position of the squeegee within the screen combine to provide both the screen-flooding and image-transfer functions in a single smooth operation that repeats with every revolution of the screen. In rotary screen printing, the web substrate moves between the rotating screen and impression cylinders. The rotating action, coupled with the squeegee position within the screen, both floods the screen with ink and shears the ink to allow continuous image transfer.

With regard to a flatbed screen press, printing involves a pass over the screen by a floodbar to fill mesh openings with ink, followed by a squeegee pass to bring the stencil and substrate into contact for ink transfer. Furthermore, to maintain good edge definition and to ensure registration accuracy on multicolor prints, each tattoo image printed on a flatbed is held stationary with a vacuum drawdown during the print cycle. Additionally, in flatbed printing, screens are typically made from polyester mesh that has been stretched onto a frame. In order to achieve good printed edge definition and detail, press operators may leave a small gap between the stencil and the substrate. During the printing cycle, the squeegee closes this gap, bringing the screen and the printing surface of the film into contact by depressing the screen. The tension of the fabric causes it to “snap off” the printing surface of the film immediately behind the moving squeegee, allowing the transferred ink to retain the detail of the stencil.

Regardless of the screen printing process or apparatus used to produce the tattoo image on the printing surface of the film, the process continues to step 130, where the printed tattoo image is dried using forced heat or is permitted to air dry at room temperature (i.e. about 23° C.) right after it has been screen printed at step 120. In one embodiment, the printed tattoo image may be dried at a temperature between 100° C. and 20° C. In another embodiment, the image may be dried at a temperature between 60° C. and 20° C. In any event, the image should be dried at a temperature below the melting point of the film on which it is printed.

Once the screen printed tattoo image is dried or cured, the process may continue to step 140, where the film and/or release liner may be rotary die cut, so that the edge of the film conforms to the outline of the printed tattoo image, thus forming individual temporary tattoos. Finally, after the tattoo images have been rotary die cut, the film may be further cut into sheets having one or more of the screen printed temporary tattoos thereon, as indicated at step 150. That is, the film may be configured to carry one or more screen printed temporary tattoos and then subsequently cut into individual sheets.

In addition, it should be appreciated that the film may be at least partially transparent or opaque, and may be formed to have any desired color or texture. For example, in one embodiment, the film may be treated with light reflecting material, such as glitter, or may be treated with chemoluminescent or photoluminescent material so that it glows when the film is viewed in dark lighting conditions. In another embodiment, the film may be treated so as to produce a holographic or 3-dimensional effect, or may be treated so that the film changes color depending on the temperature, the length of exposure to light, as well as the intensity of light. While the prior discussion sets forth treatments for the film, which carries the screen printed tattoo image thereon, it should also be appreciated that the printed tattoo image itself may be treated in the same manner described above to impart the resultant effects to the printed image. Moreover, any portion of the tape or screen printed tattoo image may be treated in the manners set forth above to provide the desired visual effect.

Once the temporary tattoos are produced, they are then applied to the skin of the recipient by removing the release liner from the adhesive surface of the film. Next, the exposed adhesive surface of the screen printed tattoo is applied upon the recipient's skin so that the screen printed tattoo is adhered thereto. As such, the screen printed temporary tattoo is held in place and displayed to give the appearance of closely matching the appearance of a traditional needle based tattoo, while providing the benefits of allowing the tattoo to be easily removed when desired. It should be appreciated that this step is carried out without the need for, and devoid of, the use of water, which is used to facilitate the adhesion of prior art transferable dye temporary tattoos to the recipient. Moreover, because of the opaque screen printed image, the recipient's skin color or tone is prevented from showing through the tattoo image, allowing the brightness of the screen printed tattoo image's colors to be retained. That is, when the screen printed tattoo image is applied to the skin of the recipient, the color gamut of the screen printed tattoo image as it was originally printed are preserved, thus providing an image with bright colors, including brighter whiteness than is provided by other temporary tattoos.

When removal of the waterless temporary tattoo is desired, it is readily lifted off of the skin, without rubbing or scratching, and without the application of cleansing or removal agents, such as alcohol and soap for example.

It will, therefore, be appreciated that one advantage of at least one embodiment of the present invention is that a method for producing a waterless temporary tattoo utilizes a screen printing process to apply a tattoo image to an adhesive film. Another advantage of at least one embodiment of the present invention is that the method for producing the waterless temporary tattoo dries the inked image using forced air heat or air drying at room temperature. Still another advantage of one or more embodiments of the present invention is that the method for producing a waterless temporary tattoo produces opaque tattoo images that have vibrant colors and bright whites, particularly when compared to other waterless temporary tattoos such as those made by the flexographic process, or by digital offset printing. An additional advantage of the present invention is that the method for producing a waterless temporary tattoo produces a temporary tattoo that is easily removable from the skin of the recipient. Thus, based upon the foregoing, it will be appreciated that the concepts described above provide an improvement in the art.

Thus, it can be seen that one or more aspects of the invention have been satisfied by the structure and methods provided above. In accordance with the Patent Statutes, only the best mode and certain alternative embodiments have been presented in the application and described in any detail. It should be understood that the spirit and scope of the appended claims should not be limited to the description of the embodiments contained herein, the true scope and breadth of the invention being defined by the claims as follows.

What is claimed is:

1. A method of producing a waterless temporary tattoo comprising:
providing a film having an adhesive surface opposite a printing surface pretreated with a corona process;
screen printing a tattoo image upon said printing surface; and
then drying said tattoo image under one of forced air heat and air drying.

2. The method of claim 1, further comprising:
rotary die cutting said film about the perimeter of said tattoo image.

3. The method of claim 2, cutting said film into sheets.

4. The method of claim 1, wherein said tattoo image comprises at least a first color image component and a second color image component.

5. The method of claim 1, wherein said screen printing step comprises:
printing a first color image component at a first color screen printing unit; and
printing a second color image component at a second color screen printing unit.

6. The method of claim 1, wherein said film comprises polyethylene.

7. The method of claim 1, wherein said tattoo image is more opaque than tattoo images produced by another process.

8. The method of claim 1, wherein said tattoo image is brighter than tattoo images produced by another process.

9. The method of claim 1, wherein said adhesive surface comprises acrylate.

10. The method of claim 1, wherein said tattoo image and said film is hypoallergenic.

11. The method of claim 1, wherein said screen printing step utilizes a screen printing press selected from the group consisting of a flat-bed roll form press, a flat-bed sheet form press, and a roll form cylinder press.

12. The method of claim 1, wherein said tattoo image is formed of cosmetic grade ink.

13. The method of claim 1, wherein a removable release liner is affixed upon said adhesive surface.

14. The method of claim 13, further comprising:
rotary die cutting said film and said release liner about the perimeter of said tattoo image.

15. The method of claim 1, wherein said screen printing step utilize ink colors that have been formulated prior to said screen printing step.

16. The method of claim 1, wherein said tattoo image is chemoluminescent.

17. The method of claim 1, wherein said tattoo image is photoluminescent.

18. The method of claim 1, wherein said tattoo image is reflective.
